(19) United States
(12) Patent Application Publication
(10) Pub. No.: US 2022/0164958 A1
(43) Pub. Date: May 26, 2022

(54) Method Of Using Camera For Both Internal And External Monitoring Of A Vehicle

(71) Applicant: Panasonic Automotive Systems Company of America, Division of Panasonic Corporation of North America, Peachtree City, CA (US)

(72) Inventor: JIN WOO JUNG, JOHNS CREEK, GA (US)

(21) Appl. No.: 17/530,097

(22) Filed: Nov. 18, 2021

Related U.S. Application Data
(60) Provisional application No. 63/117,779, filed on Nov. 24, 2020.

(51) Int. Cl. G06T 7/10; G06K 9/00; B60R 11/04

(52) U.S. Cl. CPC G06T 7/10; G06K 9/00832; B60R 2300/108; B60R 11/04; G06K 9/00791

(57) ABSTRACT

A camera has a field of view encompassing a portion of an environment outside of a motor vehicle and a portion of an environment inside a passenger compartment of the motor vehicle. An electronic processor is communicatively coupled to the camera and receives captured images from the camera. The electronic processor separates first extracted images from the captured images. The first extracted images correspond to the portion of the environment outside of the motor vehicle. The electronic processor transmits the first extracted images to a first software application for monitoring the environment outside of the motor vehicle. The electronic processor separates second extracted images from the captured images. The second extracted images correspond to the portion of the environment inside a passenger compartment. The electronic processor transmits the second extracted images to a second software application for monitoring human beings in the passenger compartment.

### CROSS-REFERENCED TO RELATED APPLICATIONS

This application claims benefit of U.S. Provisional Application No. 63/117,779, filed on Nov. 24, 2020, the disclosure of which is hereby incorporated by reference in its entirety for all purposes.

### BACKGROUND OF THE INVENTION

### 1. Field of the Invention

The present invention relates to a monitoring system, and, more particularly, to a monitoring system in a motor vehicle.

### 2. Description of the Related Art

In recent years, cars are being equipped with camera devices to add safety and convenience features. However, adding additional cameras increases the cost of the vehicle and requires extra space and cabling.

FIG. 1 illustrates an outside monitoring vehicle camera arrangement 10 of the prior art in the form of a typical surround view application setup where vehicle 11 includes a total of four cameras, including a front camera 12, a right camera 14, a rear camera 16, and a left camera 18. The curved lines from each camera show the camera's view/coverage area. As can be seen in FIG. 1, the collective field of view (FOV) of all four camera lenses is wide enough to cover the entire surroundings of the vehicle. With this setup, all four camera images can be combined and processed together to create a bird's-eye view or three-dimensional (3D) view around the vehicle to help the driver.

FIG. 2 illustrates a driver monitoring, inside monitoring vehicle camera arrangement 20 of the prior art. FIG. 2 shows the camera setup of the driver monitoring application where the camera 22 monitoring the driver is inside of a vehicle 21. The lines from the camera 22 show the camera's view/coverage area.

### SUMMARY OF THE INVENTION

The invention may provide a way to reduce the number of cameras in a motor vehicle for cases where there is at least one camera application that does inside monitoring and at least one camera application that does outside monitoring.

The invention comprises, in one form thereof, a camera arrangement for a motor vehicle, including a camera having a field of view encompassing a portion of an environment outside of the motor vehicle and a portion of an environment inside a passenger compartment of the motor vehicle. An electronic processor is communicatively coupled to the camera and receives captured images from the camera. The electronic processor separates first extracted images from the captured images. The first extracted images correspond to the portion of the environment outside of the motor vehicle. The electronic processor transmits the first extracted images to a first software application for monitoring the environment outside of the motor vehicle. The electronic processor separates second extracted images from the captured images. The second extracted images correspond to the portion of the environment inside a passenger compartment of the motor vehicle. The electronic processor transmits the second extracted images to a second software application for monitoring human beings in the passenger compartment of the motor vehicle.

The invention comprises, in another form thereof, a method of using a camera in a motor vehicle, including providing a camera having a field of view encompassing a portion of an environment outside of the motor vehicle and a portion of an environment inside a passenger compartment of the motor vehicle. First extracted images are separated from the captured images. The portion of the environment outside of the motor vehicle forms a majority of each of the first extracted images. Each of the first extracted images mostly includes the portion of the environment outside the motor vehicle. The first extracted images are transmitted to a first software application. The first software application is used to monitor the environment outside of the motor vehicle. Second extracted images are separated from the captured images. The portion of the environment inside a passenger compartment of the motor vehicle forms a majority of each of the second extracted images. Each of the second extracted images mostly includes the portion of the environment inside a passenger compartment of the motor vehicle. The second extracted images are transmitted to a second software application. The second software application is used to monitor human beings in the passenger compartment of the motor vehicle.

The invention comprises, in yet another form thereof, a camera arrangement for a motor vehicle, including a camera mounted to have a field of view encompassing a portion of an environment outside of the motor vehicle and a portion of an environment inside a passenger compartment of the motor vehicle. An electronic processor is communicatively coupled to the camera, receives captured images from the camera, and de-warps the captured images from the camera. The electronic processor separates first extracted images from the de-warped captured images. The first extracted images correspond to the portion of the environment outside of the motor vehicle. The first extracted images are transmitted to a first software application for monitoring the environment outside of the motor vehicle. The electronic processor separates second extracted images from the de-warped captured images. The second extracted images correspond to the portion of the environment inside a passenger compartment of the motor vehicle. The second extracted images are transmitted to a second software application for monitoring human beings in the passenger compartment of the motor vehicle.

An advantage of the invention is that it reduces the number of cameras, thereby reducing cost and eliminating the need for extra space and cables.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of a vehicle camera arrangement of the prior art.

FIG. 2 is a schematic diagram of another vehicle camera arrangement of the prior art.

FIG. 3 is a schematic diagram of one embodiment of a vehicle camera arrangement of the present invention.

FIG. 4 is an inside perspective view of possible locations of the left side camera of the arrangement of FIG. 3.

FIG. 5a is a high-level software block diagram for a surround view application of the prior art suitable for use with the arrangement of FIG. 1.

FIG. 5b is a high-level software block diagram for a driver monitoring application of the prior art suitable for use with the arrangement of FIG. 2.

FIG. 5c is a high-level software block diagram of a combined surround view and driver monitoring application of the present invention suitable for use with the arrangement of FIG. 3.

FIG. 6 is a diagram illustrating one embodiment of the image separation block of FIG. 5c.

FIG. 7 is a schematic diagram of another embodiment of a vehicle camera arrangement of the present invention.

FIG. 8 is a block diagram of yet another embodiment of a vehicle camera arrangement of the present invention.

FIG. 9 is a flow chart of one method of the present invention for using a camera in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

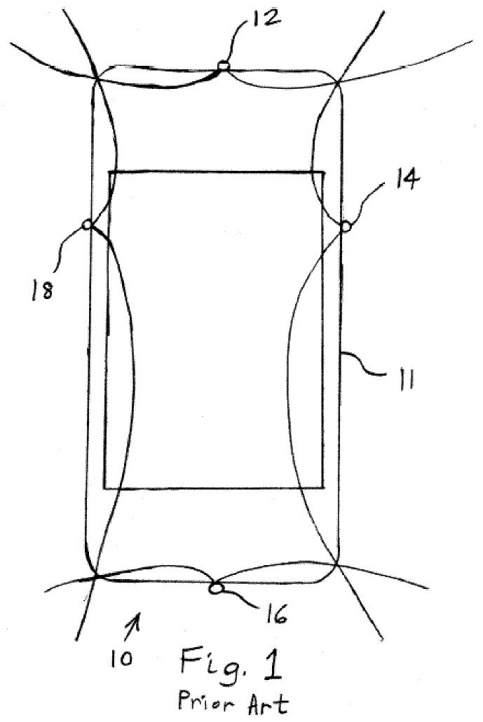

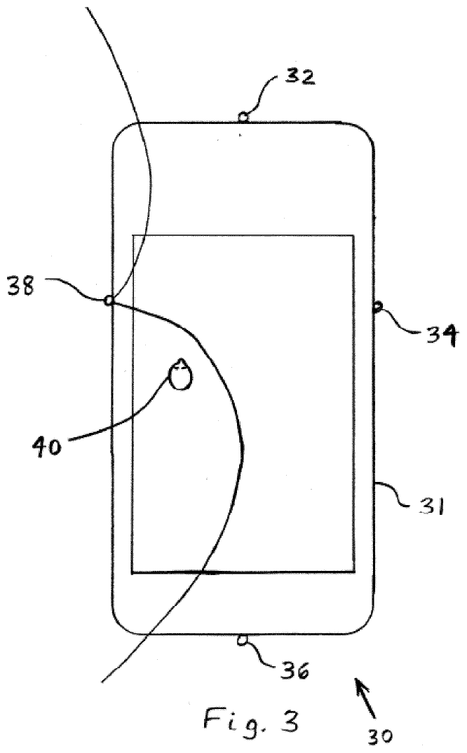

FIG. 3 illustrates one embodiment of a vehicle camera arrangement 30 of the present invention, wherein a vehicle 31 includes a front camera 32, a right camera 34, a rear camera 36, and a left camera 38. In the configuration shown in FIG. 3, the view/coverage area of left camera 38 is increased as compared to the prior art configuration of FIG. 1. Particularly, the view/coverage area of left camera 38 is increased to encompass the human driver 40. FIG. 3 illustrates the camera setup of the present invention where the one camera 38 on the left covers both inside and outside of the vehicle. The lines from camera 38 show the camera's view/coverage area.

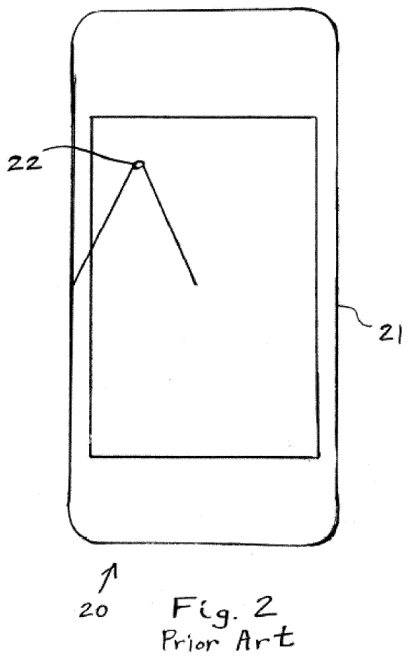

As can be seen in FIG. 3, left camera 38 can be used for both a surround view and driver monitoring, thereby reducing the number of cameras required to satisfy both applications (i.e., reducing from the five cameras shown in FIGS. 1-2 to the four cameras shown in FIG. 3). The reduction in the number of cameras from five to four can be achieved by placing camera 38 (e.g., the lens of camera 38) at a location where it can see both inside and outside vehicle 31, and by providing the lens of camera 38 with an increased or enlarged field of view (FOV).

The advantages of the invention cannot be achieved by simply increasing the FOV of the lens of camera 18 in FIG. 1 because the camera's view cannot be extended to inside the passenger compartment of vehicle 11 due to the car body or windshield in between which would block the view. Similarly, the advantages of the invention cannot be achieved by simply increasing the FOV of the lens of camera 22 in FIG. 2 because the camera's view cannot be extended to outside of vehicle 21 due to the car body or windshield in between which would block the view.

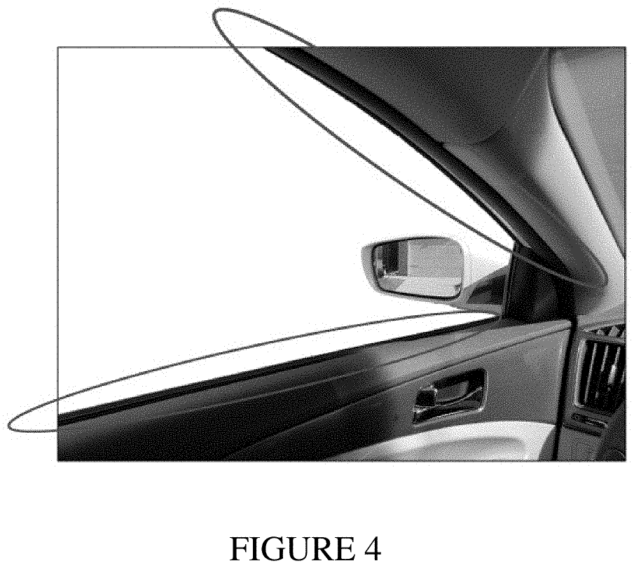

FIG. 4 illustrates possible locations of left side camera 38 of arrangement 30 of FIG. 3 where clear inside and outside views of vehicle 31 can be had. Particularly, the areas within the ovals are where there may be clear visibility of both a space inside the vehicle and a space outside the vehicle. Camera 38 may be mounted on a frame of the driver's side window, or on the door just below the bottom of the visible part of the closed window.

The present invention may call for additional software modules and image processing because there are two different applications needing different images. The surround view requires images of outside surroundings of the car, and the driver monitoring requires images of the driver inside. Thus, the invention may call for additional processing of the images captured by left camera 38 to provide the proper image to the proper application.

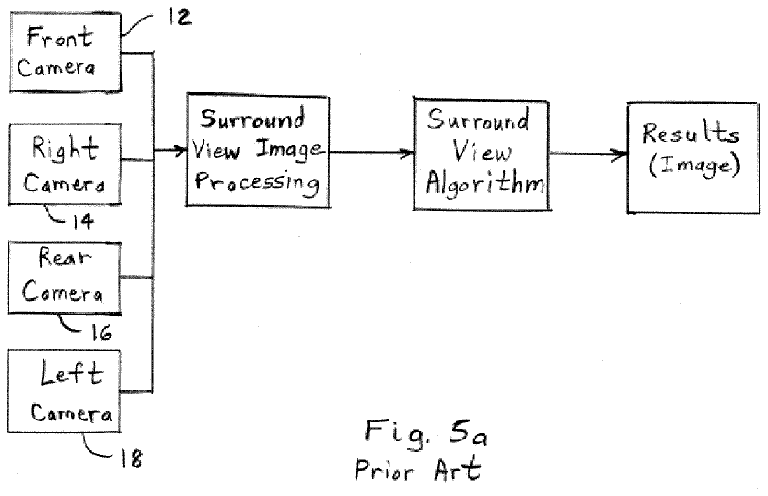

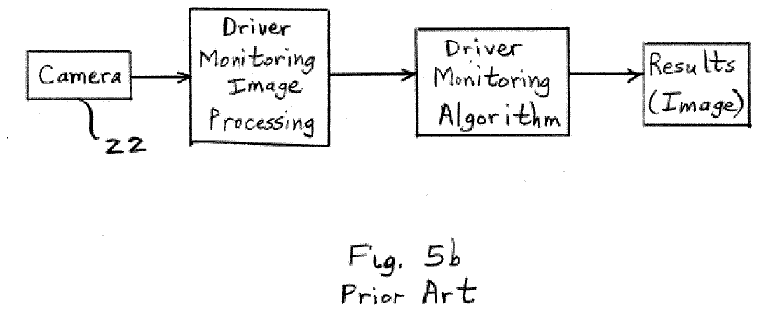

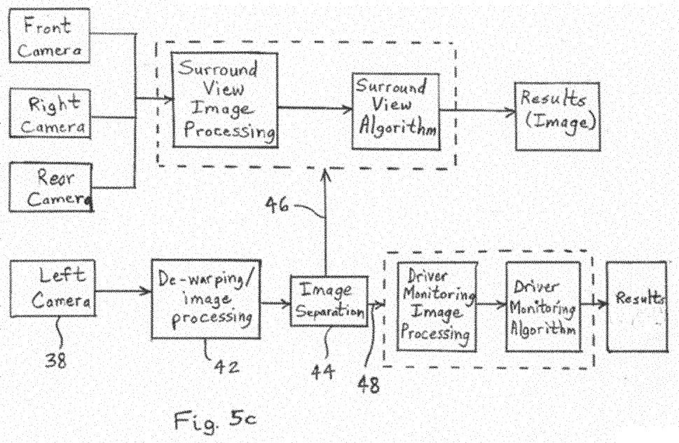

The processing of captured images is illustrated in FIGS. 5a-c. FIG. 5a illustrates a surround view application of the prior art suitable for use with the arrangement of FIG. 1. FIG. 5b illustrates a driver monitoring application of the prior art suitable for use with the arrangement of FIG. 2.

FIG. 5c illustrates a combined surround view and driver monitoring application of the present invention suitable for use with the arrangement of FIG. 3. As described above with regard to FIG. 3, left camera 38 captures images that are used for both the surround view application and the driver monitoring application. As compared to the processes of FIGS. 5a-b, the process of FIG. 5c includes the additional steps 42, 44 for using only one camera to support both surround view and driver monitor application.

As can be seen from FIG. 5c, de-warping or image processing (block 42) may be called for to obtain a correct image from the wide FOV lens of camera 38. Then, the image separation block 44 is called for to provide the correct portion of the image area to each of the two applications. The different output images of the image separation block 44 can go to the surround view application, as indicated at 46, and to the driver monitoring application, as indicated at 48. The different output images of the image separation block 44 can go to the image processing block of each application or directly to the algorithm block of each application depending on the needs.

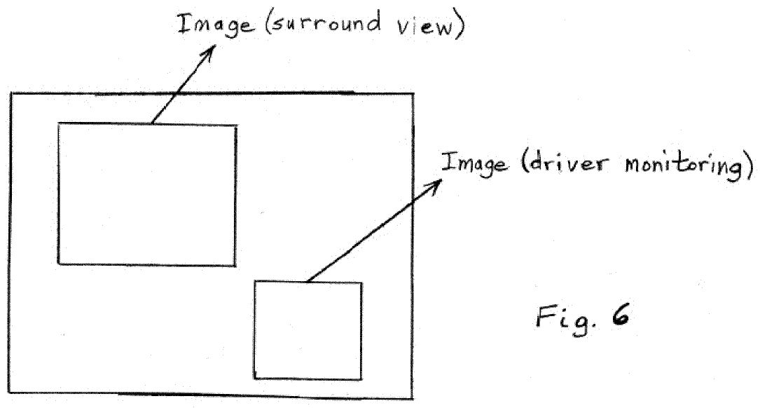

FIG. 6 illustrates an example of the image separation (into two images) performed by image separation block 44 in FIG. 5c. One portion of the image is sent to the surround view application. The other portion of the image is sent to the driver monitoring application.

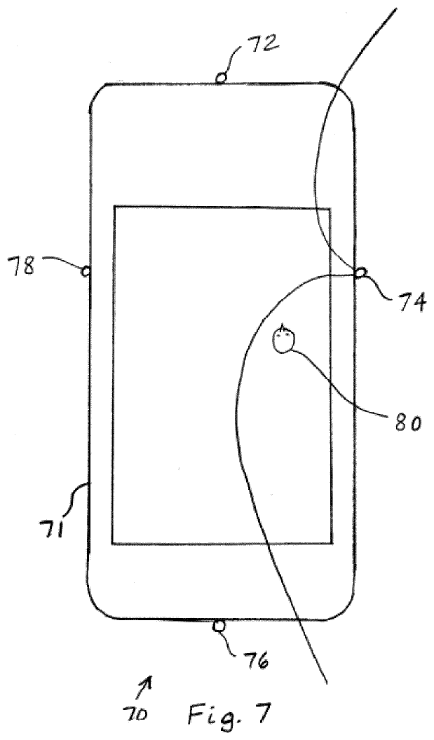

Although only one particular example of the present invention is described hereinabove for reducing the number of cameras used in surround view and driver monitor applications, there are many other ways to implement the present invention. As another example, as shown in FIG. 7, the view/coverage area of a right camera 74 can be extended just as the coverage area of left camera 38 is extended in FIG. 3.

FIG. 7 illustrates one embodiment of a vehicle camera arrangement 70 of the present invention, wherein a vehicle 71 includes a front camera 72, a right camera 74, a rear camera 76, and a left camera 78. In the configuration shown in FIG. 7, the view/coverage area of right camera 74 is increased as compared to the prior art configuration of FIG. 1. Particularly, the view/coverage area of right camera 74 is increased to encompass the human passenger 80. FIG. 7 illustrates the camera setup of the present invention where the one camera 74 on the right covers both inside and outside of the vehicle. The lines from camera 74 show the camera's view/coverage area.

As can be seen in FIG. 7, right camera 74 can be used for both a surround view and passenger monitoring, thereby reducing the number of cameras required to satisfy both applications. The reduction in the number of cameras from five to four can be achieved by placing camera 74 (e.g., the lens of camera 74) at a location where it can see both inside and outside vehicle 71, and by providing the lens of camera 74 with an increased or enlarged field of view (FOV).

In another embodiment, the coverage area of left camera 38 in FIG. 3 is even further extended to detect both the driver and passenger. The present invention may be applied to any combination of inside and outside monitoring cases. For example, the invention may be applied to a side view mirror camera application and a cabin monitoring application combination.

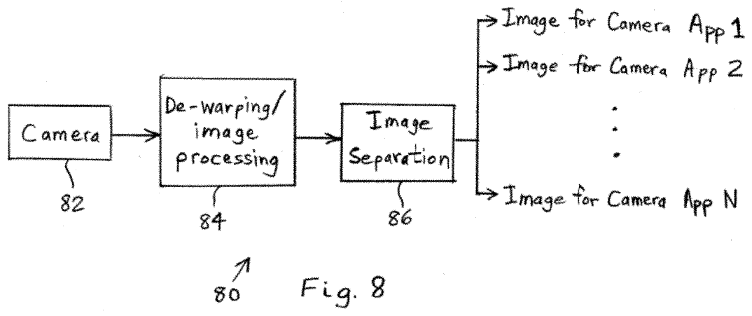

The invention may be applied to cases in which the vehicle has multiple camera applications wherein at least one camera application monitors inside and at least one camera application monitors outside. The invention may reduce the number of cameras by having at least one camera monitor both inside and outside by providing the camera with an increased FOV and placing the camera where it can clearly see both inside and outside areas that are needed by camera monitoring applications. The invention may also reduce the number of cameras by performing proper image warping/processing and image separation on the images captured by the camera that is doing both inside and outside monitoring, as shown in FIG. 8.

FIG. 8 illustrates yet another embodiment of a vehicle camera arrangement 80 of the present invention, including a camera 82, a de-warping/image processing block 84 and an image separation block 86. The images captured by camera 82 can be separated out or divided into sub-images for as many applications as needed. In FIG. 8, N number of different sub-images are produced by image separation block 86 for the N number of applications.

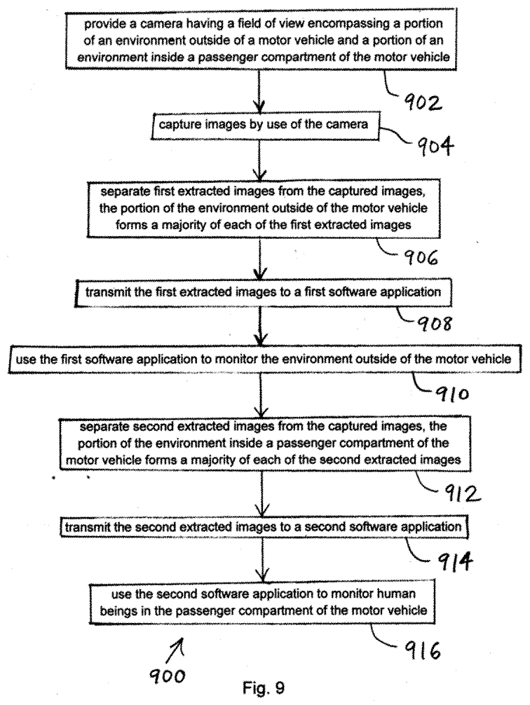

FIG. 9 illustrates one method 900 of the present invention for using a camera in a motor vehicle. In a first step 902, a camera is provided having a field of view encompassing a portion of an environment outside of the motor vehicle and a portion of an environment inside a passenger compartment of the motor vehicle. For example, camera 38 covers both inside and outside of the vehicle such that camera 38 can be used for both a surround view and driver monitoring.

Next, in step 904, images are captured by use of the camera. For example, camera 38 captures images.

In a next step 906, first extracted images are separated from the captured images. The portion of the environment outside of the motor vehicle forms a majority of each of the first extracted images. For example, image separation block 44 may provide extracted images including mostly the portion of the image area outside of the vehicle.

In step 908, the first extracted images are transmitted to a first software application. For example, the images of the outside environment extracted by the image separation block 44 can go to the surround view application.

Next, in step 910, the first software application is used to monitor the environment outside of the motor vehicle. For example, the surround view application may monitor the environment outside of the motor vehicle.

In a next step 912, second extracted images are extracted from the captured images. The portion of the environment inside a passenger compartment of the motor vehicle forms a majority of each of the second extracted images. For example, image separation block 44 may provide extracted images including mostly the portion of the image area inside the vehicle.

In step 914, the second extracted images are transmitted to a second software application. For example, the images of the inside environment extracted by the image separation block 44 can go to the driver monitoring application.

In a final step 916, the second software application is used to monitor human beings in the passenger compartment of the motor vehicle. For example, the driver monitoring application may monitor human beings in the passenger compartment of the motor vehicle.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A camera arrangement for a motor vehicle, the arrangement comprising:
a camera having a field of view encompassing a portion of an environment outside of the motor vehicle and a portion of an environment inside a passenger compartment of the motor vehicle; and
an electronic processor communicatively coupled to the camera and configured to:
receive captured images from the camera;
separate first extracted images from the captured images, the first extracted images corresponding to the portion of the environment outside of the motor vehicle;
transmit the first extracted images to a first software application, the first software application being for monitoring the environment outside of the motor vehicle;
separate second extracted images from the captured images, the second extracted images corresponding to the portion of the environment inside a passenger compartment of the motor vehicle; and
transmit the second extracted images to a second software application, the second software application being for monitoring human beings in the passenger compartment of the motor vehicle.

2. The arrangement of claim 1 wherein the camera is mounted on a door of the motor vehicle.

3. The arrangement of claim 1 wherein the portion of an environment inside a passenger compartment of the motor vehicle includes a human driver of the motor vehicle.

4. The arrangement of claim 1 wherein the electronic processor is configured to de-warp the captured images from the camera.

5. The arrangement of claim 4 wherein the electronic processor is configured to de-warp the captured images from the camera before the first extracted images and the second extracted images are separated from the captured images.

6. The arrangement of claim 1 wherein the camera is mounted on a frame of a side window of a door of the motor vehicle.

7. The arrangement of claim 1 wherein the second software application comprises a driver monitoring application.

8. A method of using a camera in a motor vehicle, the method comprising:
providing a camera having a field of view encompassing a portion of an environment outside of the motor vehicle and a portion of an environment inside a passenger compartment of the motor vehicle;
capturing images by use of the camera;
separating first extracted images from the captured images, the portion of the environment outside of the motor vehicle forms a majority of each of the first extracted images;
transmitting the first extracted images to a first software application;
using the first software application to monitor the environment outside of the motor vehicle;
separating second extracted images from the captured images, the portion of the environment inside a passenger compartment of the motor vehicle forms a majority of each of the second extracted images;
transmitting the second extracted images to a second software application; and
using the second software application to monitor human beings in the passenger compartment of the motor vehicle.

9. The method of claim 8 further comprising mounting the camera on a door of the motor vehicle.

10. The method of claim 8 wherein the portion of an environment inside a passenger compartment of the motor vehicle includes a human driver of the motor vehicle.

11. The method of claim 8 further comprising de-warping the captured images from the camera.

12. The method of claim 11 wherein the captured images from the camera are de-warped before the first extracted images and the second extracted images are separated from the captured images.

13. The method of claim 8 further comprising mounting the camera on a frame of a side window of a door of the motor vehicle.

14. The method of claim 8 wherein the second software application comprises a driver monitoring application.

15. A camera arrangement for a motor vehicle, the arrangement comprising:
a camera mounted to have a field of view encompassing a portion of an environment outside of the motor vehicle and a portion of an environment inside a passenger compartment of the motor vehicle; and
an electronic processor communicatively coupled to the camera and configured to:
receive captured images from the camera;
de-warp the captured images from the camera;
separate first extracted images from the de-warped captured images, the first extracted images corresponding to the portion of the environment outside of the motor vehicle;
transmit the first extracted images to a first software application, the first software application being for monitoring the environment outside of the motor vehicle;
separate second extracted images from the de-warped captured images, the second extracted images corresponding to the portion of the environment inside a passenger compartment of the motor vehicle; and
transmit the second extracted images to a second software application, the second software application being for monitoring human beings in the passenger compartment of the motor vehicle.

16. The arrangement of claim 15 wherein the camera is mounted on a door of the motor vehicle.

17. The arrangement of claim 15 wherein the portion of an environment inside a passenger compartment of the motor vehicle includes a human driver of the motor vehicle.

18. The arrangement of claim 15 wherein the portion of an environment inside a passenger compartment of the motor vehicle includes a human passenger of the motor vehicle.

19. The arrangement of claim 15 wherein the camera is mounted on a frame of a side window of a door of the motor vehicle.

20. The arrangement of claim 15 wherein the second software application comprises a driver monitoring application.
